(19) United States
(12) Patent Application Publication
(10) Pub. No.: US 2026/0082468 A1
(43) Pub. Date: Mar. 19, 2026

(54) INTEGRATED CIRCUIT WITH ADAPTIVE DRIVE VOLTAGE AND SWITCHING POWER SUPPLY INCLUDING THE SAME

(71) Applicant: Chengdu Monolithic Power Systems Co., Ltd., Chengdu (CN)

(72) Inventors: Junxin Tan, Hangzhou (CN); Bo Yu, Hangzhou (CN); Guanghui Li, Chengdu (CN)

(21) Appl. No.: 19/327,899

(22) Filed: Sep. 12, 2025

(30) Foreign Application Priority Data
Sep. 14, 2024 (CN) 202411291841.2

(51) Int. Cl. H05B 45/3725; H02M 3/158; H05B 45/14

(52) U.S. Cl. CPC H05B 45/3725; H02M 3/158; H05B 45/14

(57) ABSTRACT

An integrated circuit for a switching power supply is provided. The integrated circuit has a first pin coupled to one end of an inductor, a second pin coupled to the other end of the inductor and one end of a first capacitor, a third pin coupled to the other end of the first capacitor, a fourth pin coupled to a second capacitor, a fifth pin coupled to a third capacitor, a sixth pin coupled to a reference ground, a first transistor coupled between the second pin and the sixth pin, a mode determination circuit for providing a mode signal to determine a drive voltage, and a gate driver for providing the determined drive voltage to a control terminal of the first transistor based on the mode signal.

### CROSS-REFERENCE TO RELATED APPLICATIONS

This application claims the benefit of CN application 202411291841.2, filed on Sep. 14, 2024, and incorporated herein by reference.

### TECHNICAL FIELD

The present invention generally relates to electronic circuits, and more particularly but not exclusively, to integrated circuits with adaptive drive voltage and switching power supplies including the same.

### BACKGROUND

LED(Light Emitting Diode) is a solid semiconductor device that direct transmits electric energy to visible light. It has advantages such as easy control, low voltage DC driving, and long life-time. Currently, LED is widely applied on many occasions, for example, lighting, display backlighting, and display screen. A switching power supply is often used to receive an input voltage, and converts the input voltage to an appropriate output voltage for driving a load such as the LED.

### SUMMARY

There has been provided, in accordance with an embodiment of the present disclosure, an integrated circuit for a switching power supply. The integrated circuit has a first pin coupled to one end of an inductor to receive an input voltage, a second pin coupled to the other end of the inductor and one end of a first capacitor, a third pin coupled to the other end of the first capacitor, a fourth pin coupled to a second capacitor, a fifth pin coupled to a third capacitor and to provide an output voltage, a sixth pin coupled to a reference ground, a first transistor coupled between the second pin and the sixth pin, a mode determination circuit configured to provide a mode signal having a first level and a second level to determine a drive voltage, a gate driver configured to provide the determined drive voltage to a control terminal of the first transistor based on the mode signal.

There has also been provided, in accordance with an embodiment of the present disclosure, a switching power supply. The switching power supply comprises an integrated circuit, an inductor, a first capacitor, a second capacitor and a third capacitor. The integrated circuit comprises a first pin coupled to one end of the inductor to receive an input voltage, a second pin configured to be coupled to the other end of the inductor and one end of the first capacitor, a third pin configured to be coupled to the other end of the first capacitor, a fourth pin configured to be coupled to the second capacitor, a fifth pin configured to be coupled to the third capacitor, a sixth pin coupled to a reference ground, a first transistor coupled between the second pin and the sixth pin, a mode determination circuit configured to provide a mode signal having a first level and a second level to determine a drive voltage, and a gate driver configured to provide the determined drive voltage to a control terminal of the first transistor based on the mode signal.

There has also been provided, in accordance with an embodiment of the present disclosure, an integrated circuit for a switching power supply. The integrated circuit comprises a first pin configured to be coupled to one end of an inductor to receive an input voltage, a second pin configured to be coupled to the other end of the inductor and one end of a first capacitor, a third pin configured to be coupled to the other end of the first capacitor, a fourth pin configured to be coupled to a second capacitor, a fifth pin configured to be coupled to a third capacitor and to provide an output voltage; a sixth pin coupled to a reference ground, a first transistor coupled between the second pin and the sixth pin, a second transistor coupled between the second pin and the fourth pin, a third transistor is coupled between the third pin and the fourth pin, and a fourth transistor is coupled between the third pin and the fifth pin.

### BRIEF DESCRIPTION OF DRAWINGS

The present invention can be further understood with reference to the following detailed description and the appended drawings, wherein like elements are provided with like reference numerals.

FIG. 1 shows a block diagram of a switching power supply 100 in accordance with an embodiment of the present invention.

FIG. 2 shows a schematic diagram of a switching control signal used in the switching power supply 100 in accordance with an embodiment of the present invention.

FIGS. 3 and 4 respectively show operative status diagrams of the switching power supply 100 in accordance with an embodiment of the present invention.

FIG. 5 schematically illustrates a working waveform diagram of a switching power supply 100 in accordance with an embodiment of the present invention.

FIG. 6 shows a schematic diagram of a switching power supply 100A in accordance with an embodiment of the present invention.

FIG. 7 shows a schematic diagram of a switching power supply 100B in accordance with an embodiment of the present invention.

FIG. 8 illustrates a flow diagram of a method 600 of a switching power supply in accordance with an embodiment of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to “one embodiment”, “an embodiment”, “an example” or “examples” means: certain features, structures, or characteristics are contained in at least one embodiment of the present invention. These “one embodiment”, “an embodiment”, “an example” and “examples” are not necessarily directed to the same embodiment or example. Furthermore, the features, structures, or characteristics may be combined in one or more embodiments or examples. In addition, it should be noted that the drawings are provided for illustration, and are not necessarily to scale. And when an element is described as “connected” or “coupled” to another element, it can be directly connected or coupled to the other element, or there could exist one or more intermediate elements. In contrast, when an element is referred to as “directly connected” or “directly coupled” to another element, there is no intermediate element.

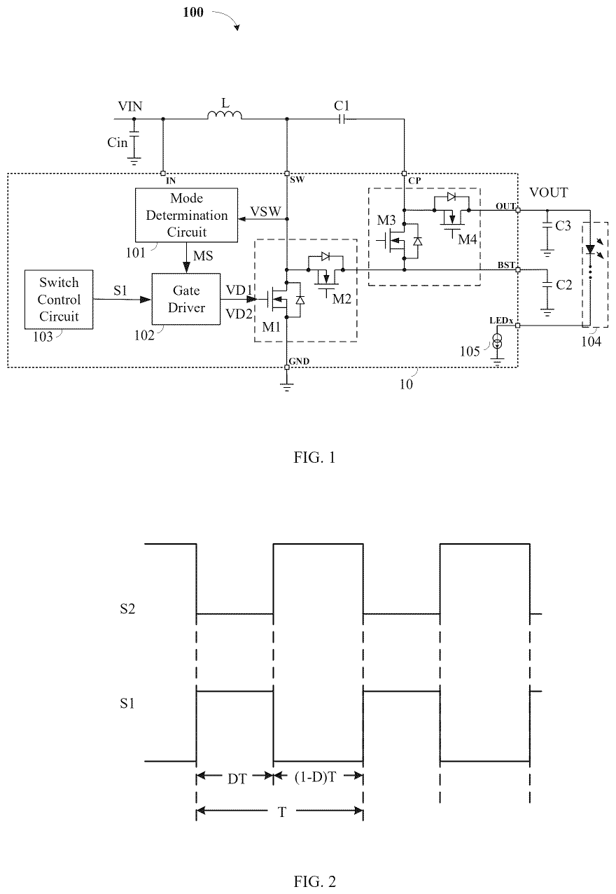

FIG. 1 shows a block diagram of a switching power supply 100 in accordance with an embodiment of the present invention. As shown in FIG. 1, the switching power supply 100 is configured to receive an input voltage VIN, to convert the input voltage VIN to an output voltage VOUT for driving a load 104 such as a LED. However, this is not intended to be limiting. In other embodiments, the switching power supply 100 may also be configured to drive any load that needs to be driven by the output voltage VOUT. In one embodiment, the output voltage VOUT provided by the switching power supply 100 may reach up to twice the input voltage VIN.

In the example of FIG. 1, the switching power supply 100 comprises a switching mode DC/DC converter that may include an energy storage component (e.g., an inductor L and capacitors C1˜C3) and power switches M1˜M4. In the example of FIG. 1, each of the power switches M1˜M4 is illustratively shown as including a MOSFET (metal oxide semiconductor field effect transistor), however this is not intended to be limiting. In other embodiments, the power switch may be any controllable semiconductor devices, such as IGBT (isolated gate bipolar transistor), SIC (Silicon Carbide), GaN (Gallium Nitride) and so on.

The switching power supply 100 shown in FIG. 1 comprises a monolithic integrated circuit 10. The monolithic integrated circuit 10 comprises a mode determination circuit 101, a gate driver 102, a first transistor M1, a second transistor M2, a third transistor M3, a fourth transistor M4, a switch control circuit 103 and a plurality of pins. As shown in FIG. 1, the plurality of pins comprises: a first pin IN, a second pin SW, a third pin CP, a fourth pin BST, a fifth pin BST, a fifth pin OUT and a sixth pin GND.

In the example shown in FIG. 1, the first pin IN is configured to be coupled to one end of the inductor L1 to receive the input voltage VIN. An input capacitor Cin is coupled between the first pin IN and a reference ground. The second pin SW is configured to be coupled to the other end of the inductor L and one end of the first capacitor C1. The third pin CP is configured to be coupled to the other end of the first capacitor C1. The fourth pin BST is configured to be coupled to one end of the second capacitor C2. The other end of the second capacitor C2 is coupled to the reference ground. The fifth pin OUT is configured to be coupled to one end of the third capacitor C3 to provide the output voltage VOUT. The other end of the third capacitor C3 is coupled to the reference ground. The sixth pin GND is coupled to the reference ground.

Referring still to FIG. 1, the first transistor M1 is coupled between the second pin SW and the sixth pin GND. The second transistor M2 is coupled between the second pin SW and the fourth pin BST. The third transistor M3 is coupled between the third pin CP and the fourth pin BST. The fourth transistor M4 is coupled between the third pin CP and the fifth pin OUT. In one embodiment, the first transistor M1 and the third transistor M3 form a first working group, the second transistor M2 and the fourth transistor M4 form a second working group. An ON state and an OFF state of the first working group and the second working group are complementary. In a first time interval of a switching cycle of the switching power supply 100, the first transistor M1 and the third transistor M3 are turned on, the second transistor M2 and fourth transistor M4 are turned off. In a second time interval of the switching cycle of the switching power supply 100, the first transistor M1 and the third transistor M3 are turned off, the second transistor M2 and the fourth transistor m4 are turned on.

In the example shown in FIG. 1, the mode determination circuit 102 is configured to provide a mode signal MS having a first level and a second level, to determine a drive voltage. In detail, the mode determination circuit 102 receives the mode signal MS and a first control signal S1 provided by the switch control circuit 103, provides the determined driver voltage to a control terminal of the first transistor M1 based on the mode signal MS.

In one embodiment, in response to the first level of (e.g., logic high) the mode signal MS, the gate driver 102 is configured to provide a first drive voltage VD1 to the control terminal of the first transistor M1, so that the first switch M1 is partially turned on. In response to the second level (e.g., logic low) of the mode signal MS, the gate driver 102 is configured to provide a second drive voltage VD2 to the control terminal of the first transistor M1, the first transistor M1 is fully turned on. The first drive voltage VD1 is less than the second drive voltage VD2.

In one embodiment, the load 104 comprises at least one LED. The fifth pin OUT of the integrated circuit 10 is coupled to an anode of at least one LED. The integrated circuit 10 further comprise a current regulator 105. The current regulator 105 has a first terminal and a second terminal. The first terminal of the current regulator 105 is coupled to the at least one LED through a pin LEDx. The second terminal of the current regulator 105 is coupled the reference ground or the sixth pin GND. In other words, the current regulator 105 can float between the output of the switching power supply 100 and the at least one LED. In one embodiment, the current regulator 105 may comprise a linear regulator or a switching mode regulator. The current regulator 105 provides a driving current based on the output voltage VOUT, to drive the at least one LED that is coupled to the fifth pin OUT of the integrated circuit 10. For clarity, the circuit details of the current regulator 105, such as linear regulation or switching mode regulation, are not shown in FIG. 1.

In another embodiment, the load 104 may comprise a plurality of LED strings that are coupled to the fifth pin OUT of the integrated circuit 10. The integrated circuit 10 comprises a plurality of current regulator. Each LED string of the plurality of LED strings has an anode coupled to the fifth pin OUT and a cathode coupled to a first terminal of the respective current regulator, and a second terminal of the respective current regulator is coupled to the reference ground. Each current regulator is configured to provide a respective driving current to the corresponding LED string.

It should be noted that some components of the switching power supply 100, such as an output current feedback loop and an output voltage feedback loop, are omitted and are not shown in FIG. 1 for clarity. The switch control circuit 103 shown in FIG. 1 controls the switching of the power switches M1˜M4 by controlling a duty cycle and/or a switching frequency, and thus to provide output power and/or the output voltage VOUT.

It would understand that a current sense component (not shown), such as a current sense resistor, may be configured to be coupled between the at least one LED and the reference ground for providing a current feedback signal to the current regulator 105.

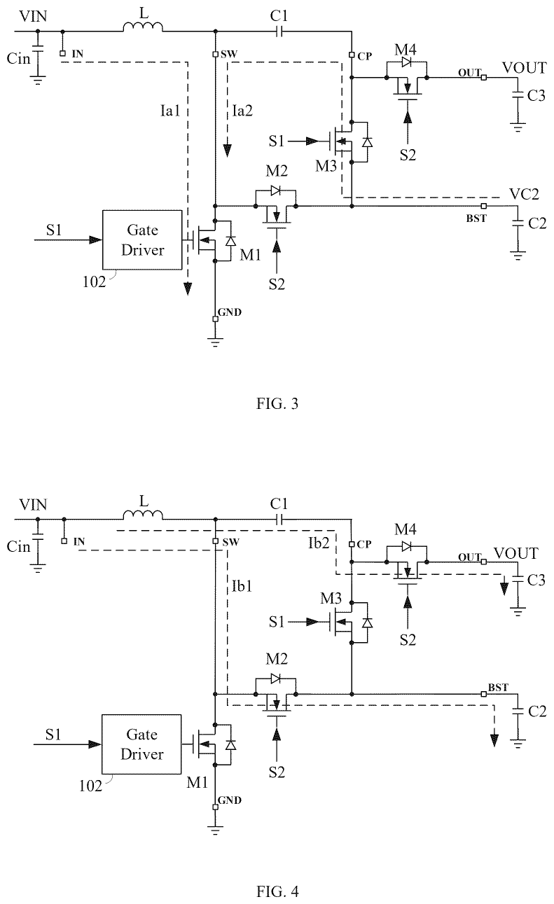

FIG. 2 shows a schematic diagram of a switching control signal used in the switching power supply 100 in accordance with an embodiment of the present invention. FIGS. 3 and 4 respectively show operative status diagrams of the switching power supply 100 in accordance with an embodiment of the present invention.

In the embodiment shown in FIG. 2, the switch control signal includes a first control signal S1 and a second control signal S2. In the examples shown in FIG. 3 and FIG. 4, the control terminal of the first transistor M1 and a control terminal of the third transistor M3 may both be coupled to receive the first control signal S1. A control terminal of the third transistor M3 and a control terminal of the fourth transistor M4 may both be coupled to receive the second control signal S2. Both the first control signal S1 and the second control signal S2 are provided by the switch control circuit 103.

In one embodiment, each one of the continuous switching cycles is fixed during a startup stage. At the starting point of each switching cycle, the first control signal S1 becomes a first level (e.g., logic high), the first transistor M1 is turned on. When a current flowing through the first transistor M1 increases to an output feedback compensation signal, the first control signal S1 becomes a second level from the first level, for example, logic low from logic high, the first transistor M1 is turned off. However, this is not intended to be limiting. In other embodiments, the switch control circuit 103 may use other common control methods to provide the first control signal S1.

As shown in FIG. 2, the second control signal S2 and the first control signa S1 are complementary. In a first time interval DT of a switching cycle T, the first control signal S1 has the first level (e.g., logic high), the second control signal S2 has the second level (e.g., logic low). Accordingly, the first transistor M1 and the third transistor M3 are turned on, the second transistor M2 and the fourth transistor M4 are turned off, as shown in the operative status of FIG. 3.

In a second time interval (1-D)T of the switching cycle T, the first control signal S1 has the second level (e.g., logic low), the second control signal S2 has the first level (e.g., logic high). Accordingly, the first transistor M1 and the third transistor M3 are turned off, the second transistor M2 and the fourth transistor M4 are turned on, as shown in the operative status of FIG. 4.

It is noted that the startup stage of the switching power supply 100 is defined as a time period when the output voltage VOUT increases from an initial value that is substantially equal to the input voltage VIN to reach a system set voltage, after the integrated circuit 10 is power on. At the starting point of the power-on stage of the integrated circuit 10, an external input source is just connected to the first pin IN of the integrated circuit 10 to receive the input voltage VIN, the power switches M1˜M4 of the integrated circuit 10 are all kept off, a voltage at the first pin IN of the integrated circuit 10 is increased from zero with a rate. The integrated circuit 10 sets an enable pin to be high when the voltage at the first pin IN increases to an enable threshold voltage. After the power-on stage of the integrated circuit 10 is finished, then the switching of the power switches M1˜M4 are allowed. The voltage at the first pin IN ultimately increases to be equal to the input voltage VIN.

In addition, during the power-on stage of the integrated circuit 10, the voltage at the first pin IN is configured to charge the second capacitor C2 through the inductor L and a body diode of the second transistor M2, and a voltage VC2 at the fourth pin BST is substantially equal to the voltage at the first pin IN. Since the first capacitor C1 substantially works at a short-circuit state, a voltage VC1 across the first capacitor C1 is substantially zero. Similarly, the voltage at the first pin IN is also configured to charge the third capacitor C3 through the inductor L, the first capacitor C1 and a body diode of the fourth transistor M4. The output voltage VOUT at the fifth pin OUT is substantially and ultimately approaching or equal to the voltage VIN at the first pin IN.

When the voltage at the first pin IN gradually increases to excess the enable threshold voltage, the enable pin of the integrated circuit 10 is set to be high, the switching of the power switch M1˜M4 are allowed. Subsequently, the output voltage VOUT at the fifth pin OUT of the integrated circuit 10 increases from the initial value that is substantially equal to the input voltage VIN at the first pin IN. When the output voltage VOUT increases to the system set voltage, the startup stage is finished.

In detail, during the startup stage, in the first time interval DT of the switching cycle T, the first control signal S1 has the first level (e.g., logic high), the first transistor M1 and the third transistor M3 are turned on, the second control signal S2 has the second level (e.g., logic low), the second transistor M2 and the fourth transistor M4 are turned off, as shown in the operative status of FIG. 3. Wherein D indicates the duty cycle of the first control signal S1. The duty cycle may refer to a ratio of the first level width of the first control signal S1 to the switching cycle T. In the first time interval DT of the switching cycle T, a current Ia1 flows from the inductor L to the reference ground through the first transistor M1. At the same time, a current Ia2 flows to the reference ground through the third transistor M3, the first capacitor C1 and the first transistor M1, the first capacitor C1 is charged, the voltage VC1 across the first capacitor C1 increases from zero. Since the output feedback compensation signal related to the output voltage VOUT is still so small during the startup stage, the duty cycle D is also small, and the current Ia2 may be much higher than the current Ia1.

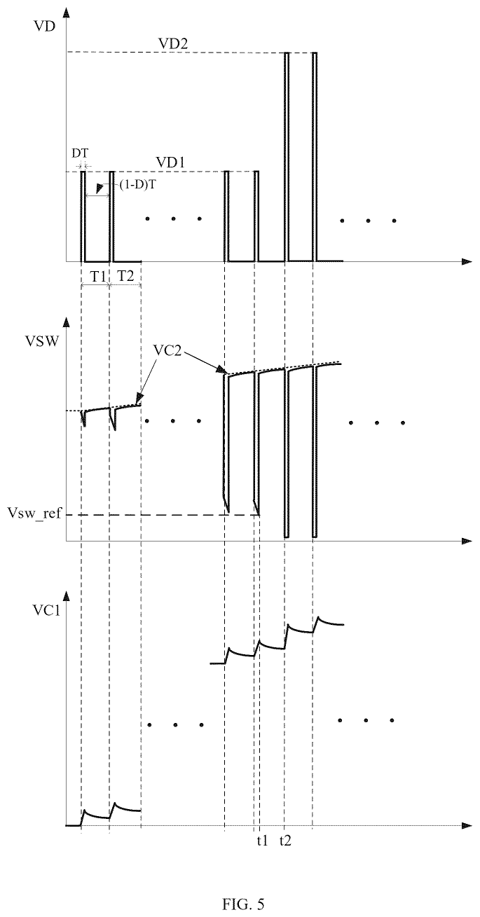

In the second time interval (1-D)T of the switching cycle T, the first control signal S1 has the second state (e.g., logic low), the first transistor M1 and the third transistor M3 are turned off, the second control signal S2 has the first level (e.g., logic high), the second transistor M2 and the fourth transistor M4 are turned on by the second control signal S2, as shown in the operative status of FIG. 4. In the second time interval (1-D)T, a current Ib1 flows to the fourth pin BST through the second transistor M2, to charge the second capacitor C2. At the same time, a current Ib2 flows though the inductor L, the first capacitor C1 and the fourth transistor M4, to the third capacitor C3, the output voltage VOUT at the fifth pin OUT is accordingly increased, and the first capacitor C1 is discharged, the voltage VC1 across the first capacitor C1 is slightly decreased. The operation of the switching power supply 100 during continuous switching cycles will be described with reference to FIG. 5.

FIG. 5 schematically illustrates a working waveform diagram of a switching power supply 100 in accordance with an embodiment of the present invention. As shown in FIG. 5, in the first time interval DT of a first switching cycle T1, when the first control signal S1 has the first level, the first drive voltage VD1 is determined and applied to the control terminal of the first transistor M1. During the first time interval DT of the first switching cycle T1, the first capacitor C1 is charged and the voltage VC1 increased from zero, the voltage VSW at the second pin SW is slightly decreased. When the first transistor M1 is turned off, the voltage VSW at the second pin SW increases and returns to be substantially equal to the voltage VC2 at the fourth pin BST. In the second time interval (1-D)T of the first switching cycle T1, the first capacitor C1 is discharged, the voltage VC1 slowly decreases, but will not decrease to zero, the voltage VSW at the second pin SW substantially follow the voltage VC2 at the fourth pin BST.

After that, during each first time interval DT of the subsequent continuous switching cycles, when the first control signal S1 has the first level, the first drive voltage VD1 is determined and is applied to the control terminal of the first transistor M1, the first transistor M1 is partially turned on. The voltage VC1 starts to increase from the current value, the voltage VSW at the second pin SW starts to decrease again. Finally, the voltage VSW at the second pin SW during the first time interval DT of the second switching cycle T2 will less than the voltage VSW during the first time interval of the first switching cycle T1.

During the first time interval of the subsequent switching cycles, the voltage VC1 continues to increase little by little, the voltage VSW at the second pin SW continues to decrease little by little.

When the first drive voltage VD1 is determined and is used to drive the first transistor M1, the first transistor M1 is partially turned on, and is not fully turned on, the current Ia1 and Ia2 (as shown in FIG. 3) flowing through the first transistor M1 are limited to avoid damage to the first transistor M1 from a current spike or a voltage spike. In one embodiment, the sum of the current Ia1 and Ia2 is limited to be a constant value, e.g., 1A.

At the time t1, the voltage VC1 equals the volage VC2 across the second capacitor C2, i.e., the voltage at the fourth pin BST, the voltage VSW at the second pin SW decreases to less than a threshold voltage VSW_Ref during the first time interval DT of the current switching cycle. In response to the voltage VSW being less than the threshold voltage VSW_Ref, the second drive voltage VD2 is determined and used to drive the first transistor M1 in the subsequent switching cycles. For example, at time t1, the determined drive voltage becomes the second drive voltage VD2 from the first drive voltage VD1. The second drive voltage VD2 is higher than the first drive voltage VD1.

When the second drive voltage VD2 is determined and is used to drive the first transistor M1, the first transistor M1 is fully turned on, and the efficiency of the switching power supply 100 can be improved to be a higher standard.

After that, during the switching cycles, the voltage VC1 across the first capacitor C1 continues to increase, the voltage VSW at the second pin SW is kept to be a first value that is less than the threshold voltage VSW_Ref during the first time intervals of the continuous switching cycles. In one example, the first value approaches zero or slightly higher than zero. The voltage VSW at the second pin SW is maintained to substantially follow the voltage VC2 at the fourth pin BST during the second time intervals of the continuous switching cycles.

As discussed above, the output voltage VOUT continues to increase, until increases to the system set voltage, the startup stage is finished. It should be understood that the determined drive voltage applied to the control terminal of the first transistor M1 changes from the first drive voltage VD1 to the second drive voltage VD2 during the startup stage.

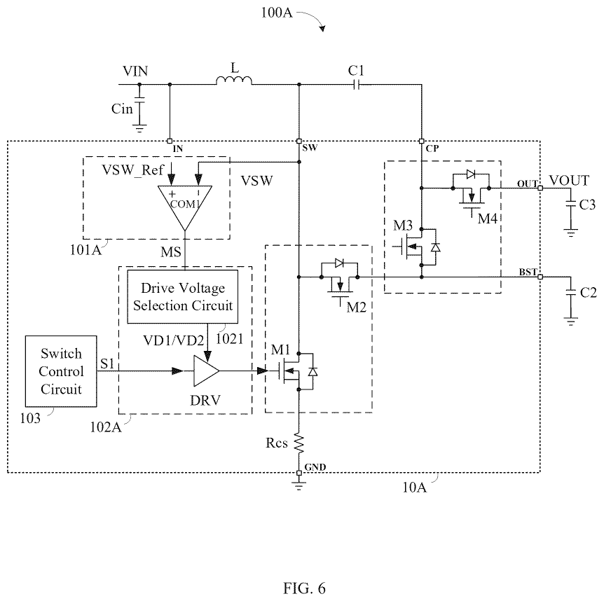

FIG. 6 shows a schematic diagram of a switching power supply 100A in accordance with an embodiment of the present invention. As shown in FIG. 6, the integrated circuit 10A comprises the plurality of pins, power switches M1˜M4, a mode determination circuit 101A, a gate driver 102A, a switch control circuit 103 and a current sense resistor Rcs.

In the embodiment shown in FIG. 6, the current sense resistor Rcs is coupled between the first transistor M1 and the sixth pin GND, and is configured to sense a current flowing through the first transistor M1 for providing a current sense signal. The current sense signal is representative of the current flowing through the first transistor M1. At the starting points of each switching cycle during the startup stage, the switch control circuit 103 provides the first control signal S1 with the first level, the first transistor M1 is turned on. When the current sense signal increases to the output feedback compensation signal, the switch control circuit 103 provides the first control signal S1 with the second level, the first transistor M1 is turned off.

In the example shown in FIG. 6, the mode determination circuit 101A is coupled to the second pin SW of the integrated circuit 10A, and compares the voltage VSW at the second pin SW with the threshold voltage VSW_ref, and provides the mode signal MS at an output terminal based on the comparison result. During the ON state of the first transistor M1, in response to the voltage VSW being higher than the threshold voltage VSW_Ref, the mode signal MS has the first level. During the ON state of the first transistor M1, in response to the voltage VSW being decreasing to the threshold voltage VSW_Ref, the mode signal MS becomes the second level from the first level.

In the example shown in FIG. 6, the mode determination circuit 101A includes a comparator COM1. A non-inverting input terminal of the comparator COM1 receives the threshold voltage VSW_Ref, an inverting input terminal of the comparator COM1 is coupled to the second pin SW of the integrated circuit to receive the voltage VSW. During the ON state of the first transistor M1, the comparator COM1 compares the voltage VSW and the threshold voltage VSW_Ref, and provides the mode signal MS to the gate driver 102A.

In the example shown in FIG. 6, the gate driver 102A comprises a drive voltage selection circuit 1021 and a driver circuit DRV. The drive voltage selection circuit 1021 is configured to select one of the first drive voltage VD1 and the second drive voltage VD2 as a power supply voltage of the driver circuit DRV. The driver circuit DRV has an input terminal, a power supply terminal and an output terminal. The input terminal of the driver circuit DRV receives the first control signal S1, the power supply terminal of the driver circuit DRV receives the determined drive voltage provided by the drive voltage selection circuit 1021, and the output terminal of the driver DRV is coupled to the control terminal of the first transistor M1.

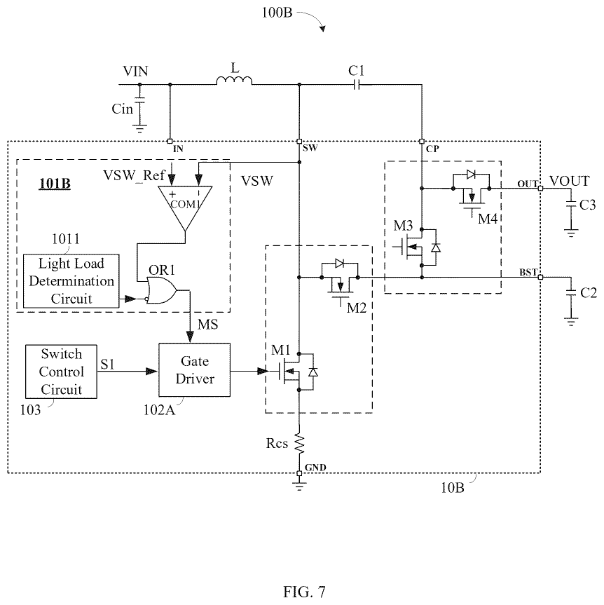

FIG. 7 shows a schematic diagram of a switching power supply 100B in accordance with an embodiment of the present invention. As shown in FIG. 7, the integrated circuit 100B comprises a plurality of pins, transistors M1˜M4, a mode determination circuit 101B, a gate driver 102A, a switch control circuit 103 and a current sense resistor Rcs.

After the startup stage, the switching power supply 100B continues to provide the appropriate output voltage VOUT to the load. In some cases, the switching cycles T of the switching power supply 100B will change with the variable load. Compared with a light load, the non-light load may consume more load current. In one embodiment, a light load condition is identified when the load current is less than a load current threshold. In another embodiment, a light load condition is identified when the switching power supply 100B enters to a skip mode from continuous current mode (CCM).

In one embodiment, when the switching mode power supply 100B provides the output voltage VOUT or output power for a lighter load, the switching cycle T of the switching mode power supply 100B increases. If the switching cycle T is too long, a drive voltage provided to the second transistor M2 and the fourth transistor M4 may not be high enough. In some worse cases, the drive voltage provided to the second transistor M2 and the fourth transistor M4 may even decrease to below an undervoltage lockout threshold. In addition, due to the built-in gate-source capacitance between the second transistor M2 and the fourth transistor M4, if the voltage VSW at the second pin SW drops too rapidly, it will further cause the second transistor M2 and the second transistor M4 to enter an uncontrollable state.

To ensure that the transistors of the first working group and the transistors of the second working group are complementary and avoid shoot through, the integrated circuit 10B shown in FIG. 7 shows a mode determination circuit 101B. As shown in FIG. 7, the mode determination circuit 101B comprises a comparator COM1, a light load determination circuit 1011 and an OR gate circuit OR1.

On one hand, during the startup stage, the mode determination circuit 101B is configured to compare the voltage VSW at the second pin SW with the threshold voltage VSW_Ref during the ON state of the first transistor M1, to provide the mode signal MS based on the comparison result. On the other hand, after the startup stage, the mode determination circuit 101B is also configured to identify a light load condition of the load coupled to the fifth pin OUT, and to provide the mode signal MS with the first level when the light load condition is identified.

In one embodiment, during the startup stage, during the ON state of the first transistor M1, in response to the voltage VSW being higher than the threshold voltage VSW_Ref, the mode signal MS with the first level is provided. Otherwise, the mode signal MS becomes the second level from the first level. After the startup stage, in response to the light load condition, the mode signal MS becomes the first level from the second level.

In an example, as shown in FIG. 6, the OR gate circuit OR1 has a first input terminal, a second input terminal, and an output terminal. The first input terminal of the OR gate circuit OR1 is coupled to the output terminal of the comparator COM1, and the second input terminal is coupled to the output terminal of the light load determination circuit 1011. The output terminal of the OR gate circuit OR1 provides the mode signal MS at its output terminal.

In an example, when the switching frequency of the switching power supply 100B approaches a first frequency threshold, the light load condition of the load is identified by the light load determination circuit 1011, and the mode signal MS with the first level is provided to the gate driver 102A. and thus the lower first drive voltage VD1 is applied to the control terminal of the first transistor M1 under the control of the gate driver 102A. When the first drive voltage VD1 is used to drive the first transistor M1 under the light load condition, it helps the first transistor M1 to turn on slowly and turn off quickly, thereby ensuring the complementary operation between the first working group (M1 and M3) and the second working group (M2 and M4).

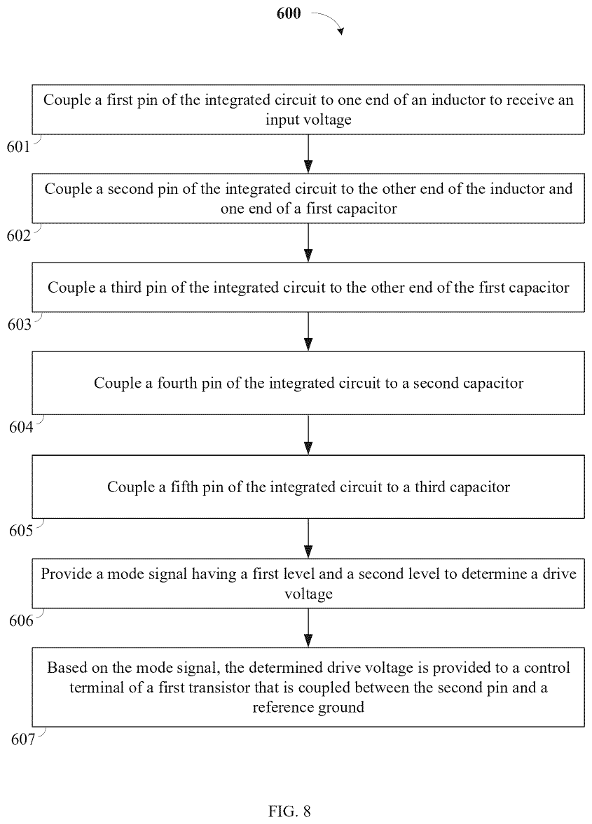

FIG. 8 illustrates a flow diagram of a method 600 of a switching power supply in accordance with an embodiment of the present invention. The switching power supply comprises an integrated circuit and provides an output voltage to a load. The method 600 comprises steps 601 to 607.

At step 601, a first pin of the integrated circuit is configured to be coupled to one end of an inductor to receive an input voltage.

At step 602, a second pin of the integrated circuit is configured to be coupled to the other end of the inductor and one end of a first capacitor.

At step 603, a third pin of the integrated circuit is configured to be coupled to the other end of the first capacitor.

At step 604, a fourth pin of the integrated circuit is configured to be coupled to one end of a second capacitor, and the other end of the second capacitor is coupled to a reference ground.

At step 605, a fifth pin of the integrated circuit is configured to be coupled to one end of a third capacitor, and the other end of the third capacitor is coupled to the reference ground.

At step 606, a mode signal having a first level and a second level is provided to determine a drive voltage.

In one embodiment, a first voltage at the second pin is compared with a first threshold voltage during an ON state of the first transistor, to provide the mode signal based on the comparison. In a further embodiment, during the ON state of the first transistor, in response to the first voltage at the second pin of the integrated circuit being higher than the first threshold voltage, the mode signal has the first level. During the ON state of the first transistor, in response to the first voltage at the second pin of the integrated circuit being less than the first threshold voltage, the mode signal has the second level.

In another embodiment, in response to identifying a light load condition of a load coupled to the fifth pin of the integrated circuit, the mode signal having the first level is provided thereto.

At step 607, based on the mode signal, the determined drive voltage is provided to a control terminal of a first transistor, the first transistor is coupled between the second pin of the integrated circuit and the reference ground.

In one embodiment, in response to the first level of the mode signal, a first drive voltage is determined and is provided to the control terminal of the first transistor. In response to the second level of the mode signal, a second drive voltage is determined and is provided to the control terminal of the first transistor. The first drive voltage is less than the second drive voltage.

In another embodiment, a second transistor is coupled between the second pin and the fourth pin, a third transistor is coupled between the third pin and the fourth pin; a fourth transistor is coupled between the third pin and the fifth pin. In a first time interval of a switching cycle of the switching power supply, the first and third transistors are turned on and the second and fourth transistors are turned off. In a second time interval of the switching cycle of the switching power supply, the first and third transistors are turned off and the second and fourth transistors are turned on.

In an example, during an ON state of the first transistor, a first voltage at the second pin of the integrated circuit is decreased, and during an OFF state of the first transistor, the first voltage at the second pin of the integrated circuit is increased to follow a second voltage at the fourth pin of the integrated circuit.

In an embodiment, during the startup stage, the first voltage at the second pin of the integrated circuit increases from zero to approach the second voltage at the fourth pin of the integrated circuit during continuous switching cycles of the first transistor.

It is to be understood that “substantially” is a term of art, and is meant to convey the principle that relationship such simultaneity or perfect synchronization cannot be met with exactness, but only within the tolerances of the technology available to a practitioner of the art under discussion.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. An integrated circuit for a switching power supply, comprising:
a first pin configured to be coupled to one end of an inductor to receive an input voltage;
a second pin configured to be coupled to the other end of the inductor and one end of a first capacitor;
a third pin configured to be coupled to the other end of the first capacitor;
a fourth pin configured to be coupled to a second capacitor;
a fifth pin configured to be coupled to a third capacitor and to provide an output voltage;
a sixth pin coupled to a reference ground;
a first transistor coupled between the second pin and the sixth pin;
a mode determination circuit configured to provide a mode signal having a first level and a second level to determine a drive voltage; and
a gate driver configured to provide the determined drive voltage to a control terminal of the first transistor based on the mode signal.

2. The integrated circuit of claim 1, wherein:
in response to the first level of the mode signal, the gate driver is configured to provide a first drive voltage to the control terminal of the first transistor; and
in response to the second level of the mode signal, the gate driver is configured to provide a second drive voltage to the control terminal of the first transistor, wherein the first drive voltage is less than the second drive voltage.

3. The integrated circuit of claim 1, wherein the mode determination circuit is coupled to the second pin, a first voltage at the second pin is compared with a first threshold voltage during an ON state of the first transistor, the mode determination circuit is configured to provide the mode signal based on the comparison.

4. The integrated circuit of claim 3, wherein:
during the ON state of the first transistor, in response to the first voltage being higher than the first threshold voltage, the mode signal has the first level; and
during the ON state of the first transistor, in response to the first voltage being less than the first threshold voltage, the mode signal has the second level.

5. The integrated circuit of claim 1, wherein the mode determination circuit is configured to identify a light load condition at the fifth pin and to provide the mode signal having the first level thereto.

6. The integrated circuit of claim 1, wherein the fifth pin of the integrated circuit is configured to be coupled to an anode of at least one LED, and the integrated circuit further comprises:
a current regulator coupled to a cathode of the at least one LED for providing a driving current for the at least one LED.

7. The integrated circuit of claim 1, wherein a second transistor is coupled between the second pin and the fourth pin, a third transistor is coupled between the third pin and the fourth pin; a fourth transistor is coupled between the third pin and the fifth pin, and wherein:
in a first time interval of a switching cycle of the switching power supply, the first and third transistors are turned on and the second and fourth transistors are turned off; and
in a second time interval of the switching cycle of the switching power supply, the first and third transistors are turned off and the second and fourth transistors are turned on.

8. The integrated circuit of claim 1, wherein:
during an ON state of the first transistor, a first voltage at the second pin is decreased; and
during an OFF state of the first transistor, the first voltage at the second pin is increased to follow a second voltage at the fourth pin.

9. The integrated circuit of claim 8, wherein the first voltage increases from zero to approach the second voltage during continuous switching cycles of the first transistor.

10. The integrated circuit of claim 8, wherein the second voltage is built from an initial voltage that is substantially equal to the input voltage.

11. A switching power supply, comprising:
an inductor;
a first capacitor;
a second capacitor;
a third capacitor; and
an integrated circuit comprising:
a first pin configured to be coupled to one end of the inductor to receive an input voltage;
a second pin configured to be coupled to the other end of the inductor and one end of the first capacitor;
a third pin configured to be coupled to the other end of the first capacitor;
a fourth pin configured to be coupled to the second capacitor;
a fifth pin configured to be coupled to the third capacitor and to provide an output voltage;
a sixth pin coupled to a reference ground;
a first transistor coupled between the second pin and the sixth pin;
a mode determination circuit configured to provide a mode signal having a first level and a second level, to determine a drive voltage; and
a gate driver configured to provide the determined drive voltage to a control terminal of the first transistor based on the mode signal.

12. The switching power supply of claim 11, wherein:
in response to the first level of the mode signal, the gate driver is configured to provide a first drive voltage to the control terminal of the first transistor; and
in response to the second level of the mode signal, the gate driver is configured to provide a second drive voltage to the control terminal of the first transistor, wherein the first drive voltage is less than the second drive voltage.

13. The switching power supply of claim 11, wherein the mode determination circuit is coupled to the second pin, a first voltage at the second pin is compared with a first threshold voltage during an ON state of the first transistor, the mode determination circuit is configured to provide the mode signal based on the comparison.

14. The switching power supply of claim 13, wherein:
during the ON state of the first transistor, in response to the first voltage being higher than the first threshold voltage, the mode signal has the first level; and
during the ON state of the first transistor, in response to the first voltage being less than the first threshold voltage, the mode signal has the second level.

15. The switching power supply of claim 11, wherein the mode determination circuit is configured to identify a light load condition at the fifth pin and to provide the mode signal having the first level thereto.

16. The switching power supply of claim 11, wherein:
during an ON state of the first transistor, a first voltage at the second pin is decreased; and
during an OFF state of the first transistor, the first voltage at the second pin is increased to follow a second voltage at the fourth pin.

17. An integrated circuit for a switching power supply, comprising:
a first pin configured to be coupled to one end of an inductor to receive an input voltage;
a second pin configured to be coupled to the other end of the inductor and one end of a first capacitor;
a third pin configured to be coupled to the other end of the first capacitor;
a fourth pin configured to be coupled to a second capacitor;
a fifth pin configured to be coupled to a third capacitor and to provide an output voltage;
a sixth pin coupled to a reference ground;
a first transistor coupled between the second pin and the sixth pin;
a second transistor coupled between the second pin and the fourth pin;
a third transistor is coupled between the third pin and the fourth pin; and
a fourth transistor is coupled between the third pin and the fifth pin.

18. The integrated circuit of claim 17, further comprises:
a mode determination circuit configured to provide a mode signal having a first level and a second level to determine a drive voltage; and
a gate driver configured to provide the determined drive voltage to a control terminal of the first transistor based on the mode signal.

19. The integrated circuit of claim 18, wherein:
in response to the first level of the mode signal, the gate driver is configured to provide a first drive voltage to the control terminal of the first transistor; and
in response to the second level of the mode signal, the gate driver is configured to provide a second drive voltage to the control terminal of the first transistor, wherein the first drive voltage is less than the second drive voltage.

20. The integrated circuit of claim 18, wherein the mode determination circuit is coupled to the second pin, a first voltage at the second pin is compared with a first threshold voltage during an ON state of the first transistor, the mode determination circuit is configured to provide the mode signal based on the comparison.
